(19) United States
(12) Patent Application Publication
(10) Pub. No.: US 2025/0339848 A1
(43) Pub. Date: Nov. 6, 2025

(54) SO2 TOLERANT CATALYSTS AND METHOD FOR PREPARING SAME

(71) Applicant: W. L. Gore & Associates, Inc., Newark, DE (US)

(72) Inventors: Vladimiros Nikolakis, Newark, DE (US); Zhuonan Song, Elkton, MD (US)

(21) Appl. No.: 18/866,435

(22) PCT Filed: May 16, 2023
(86) PCT No.: PCT/US2023/022314

§ 371 Date: Nov. 15, 2024

Related U.S. Application Data
(60) Provisional application No. 63/342,342, filed on May 16, 2022.

(51) Int. Cl. B01J 23/20; B01D 53/94; B01J 21/06; B01J 21/08; B01J 37/08

(52) U.S. Cl. CPC B01J 23/20; B01D 53/9418; B01J 21/063; B01J 21/08; B01J 37/08; B01D 2255/20723

(57) ABSTRACT

Various aspects of the present disclosure are directed towards apparatuses, systems, and methods of preparing catalysts. In some embodiments, a catalyst includes a catalytically active component and a support material comprising TiO2 having a crystal structure comprising an anatase phase and a secondary material. In some embodiments, the support material includes a secondary material such as SiO₂, MoO₃, WO₃, and Al₂O₃.

### CROSS-REFERENCE TO RELATED APPLICATION

This application national phase application of PCT Application No. PCT/US2023/022314, internationally filed on May 16, 2023, which claims the benefit of Provisional Application No. 63/342,342, filed May 16, 2022, which are incorporated herein by reference in their entireties for all purposes.

### FIELD

The present disclosure relates generally to SO₂ tolerant supported catalysts, and methods of preparing supported catalysts. More specifically, the present disclosure relates to supported catalysts and methods of preparing supported catalysts by dry mixing and thermal treatment.

### BACKGROUND

Conventional methods used to produce a supported catalyst generally include pellet or support preparation, liquid impregnation of catalyst supports in solutions containing catalyst precursors, followed by drying process to remove the liquid, followed by calcination process. The liquid impregnation and drying step typically take longer than five hours, and the calcination step when performed after liquid impregnation and drying may also take more than five hours.

In addition, some of the commercially available DeNOx catalysts (e.g., catalysts used to remove NO and NO₂) are not ideal to be directly used in the filter bags. For example, monolith DeNOx catalyst and pellet DeNOx catalyst need to be milled into smaller particles, and some of the commercial powdered DeNOx catalysts do not have sufficient catalytic activity, particle size distribution, shape, or morphology to maximize catalytic performance in the filter bag form.

Further, air pollution has attracted extensive attention throughout the world. Numerous counties have released stringent emission requirements to minimize NOx emissions during the past few years. While in general DeNOx catalytic filters systems are known, fast deactivation of DeNOx catalysts may occur under certain operation conditions prevalent in particular industries (e.g., industries where processes are conducted at a lower temperature, or involve having a higher concentration of SO₂ such as cement production).

Thus, there is a need for low-temperature selective catalytic reduction (“SCR”) DeNOx catalyst with high SO₂ tolerance and more efficient production methods of making these catalysts. There is also a need for improvements to methods for removing NOx compounds, dioxin and dioxin like compounds, halogenated compounds, and fine particulate matters from industrial flue gases, such as cement production plant flue gas.

### SUMMARY

The present disclosure generally relates to SO₂ tolerant catalysts and methods for preparing a SO₂ tolerant supported catalyst which may include mixing a dry catalyst precursor including a metal and a ligand with a dry support material to form a mixture, and calcining the mixture.

According to a first embodiment (“Embodiment 1”), provided is a catalyst including a catalytically active component and a support material including TiO₂ having a crystal structure including an anatase phase. In some embodiments, the support material includes a secondary material.

Embodiment 2 is the catalyst of Embodiment 1, wherein the secondary material is selected from the group comprising at least one of SiO₂, MoO₃, WO₃, and Al2O₃.

Embodiment 3 is the catalyst of Embodiments 1-2, wherein the secondary material has a weight percentage of from 2% to 35% based on a total weight of the catalyst.

Embodiment 4 is the catalyst of Embodiments 1-3, wherein the secondary material is SiO₂.

Embodiment 5 is the catalyst of Embodiments 1-4, wherein a ratio [(Ia/Ib)×100] of an intensity of a peak indicating an anatase crystal present in a range of 2 θ=24.7° to 2 θ=25.7° of powder X-ray diffraction of the TiO₂ [Ia] to the intensity of the peak indicating the anatase crystal present in the range of 2 θ=24.7° to 2 θ=25.7° of powder X-ray diffraction of a standard sample composed of anatase titanium oxide [Ib] is from 30% to 360%.

Embodiment 6 is the catalyst of Embodiments 1-5, wherein the catalyst has an NOx removal efficiency of from 30% to 90% at a temperature range of from 150° C. to 280° C.

Embodiment 7 is the catalyst of Embodiment 6, wherein the catalyst has an apparent reaction rate constant from 40 to 400 cm³/gs at a temperature range of from 150° C. to 280° C. for a Selective Catalytic Reduction of NOx with NH₃.

Embodiment 8 is the catalyst of Embodiments 1-7, wherein the catalyst has an NOx removal efficiency of from 60% to 80% from a temperature ranging from 170° C. to 220° C.

Embodiment 9 is the catalyst of Embodiments 1-8, wherein the catalyst has a reduced initial deactivation rate compared to a catalyst including a support material having TiO₂ when tested in a Selective Catalytic Reduction of NOx with NH₃ in the presence of SO₂.

Embodiment 10 is the catalyst of Embodiments 1-9, wherein the support material has a specific surface area of from 50 to 500 m²/g.

Embodiment 11 is the catalyst of Embodiments 1-10, wherein the catalytically active component includes at least one of: Vanadium Monoxide (VO), Vanadium Trioxide (V₂O₃), Vanadium Dioxide (VO₂), Vanadium Pentoxide (V₂O₅), Molybdenum Trioxide (MoO₃), Manganese Oxide (MnO₂), Iron (III) oxide (Fe₂₀₃), Iron (II) oxide (FeO), Copper Oxide (CuO) or any combination thereof.

Embodiment 12 is the catalyst of Embodiments 1-11, wherein the catalytically active component has a loading percentage by weight of 4% to 50% based on total weight of the catalyst.

Embodiment 13 is the catalyst of Embodiments 1-12, wherein the catalytically active component has a loading percentage by weight of 10% to 30% based on total weight of the catalyst.

Embodiment 14 is the catalyst of Embodiments 1-13, wherein the support material includes particles having a mean diameter of from 0.5 μm to 1000 μm.

Embodiment 15 is the catalyst of Embodiments 1-14, wherein the catalytically active component is V₂O₅, the support material is TiO₂, and the secondary material is SiO₂.

Embodiment 16 is a catalytic article including the catalyst of Embodiments 1-15.

Embodiment 17 is a method for catalyzing a reaction including contacting a reactant stream with the catalyst of Embodiments 1-15.

Embodiment 18 is the catalyst of claims 1-15 or the catalytic article of claim 16, wherein the catalyst or catalytic article has an NOx removal efficiency of from 10% to 99% at a temperature range of from 150° C. to 280° C.

Embodiment 19 is a method to reduce an amount of a compound from a gas stream including: providing a first gas stream having the compound at a first concentration, and contacting the gas stream with the catalytic article of Embodiment 16 forming a second gas stream having the compound at a second concentration. In some embodiments, the first concentration is greater than the second concentration.

Embodiment 20 is the method of Embodiment 19, wherein the first gas stream includes SO₂ at a concentration of from 1 to 200 ppm.

Embodiment 21 is the method of Embodiments 19-20, wherein the compound includes NOx.

Embodiment 22 is the method of Embodiments 19-21, wherein the compound includes at least one of Nitrogen (N₂), dioxin or a dioxin-like compound, a halogen, or a halogenated compound.

Embodiment 23 is the method of Embodiments 19-22, wherein the first gas stream further includes at least one of Oxygen (O₂), Water (H₂O), Carbon Monoxide (CO), Carbon Dioxide (CO₂), Sulfur Dioxide (SO₂), Sulfur Trioxide (SO₃), a hydrocarbon, or one or more organic or inorganic materials and the like.

Embodiment 24 is the method of Embodiments 19-23, wherein the gas stream is a flue gas stream having a temperature of between 140 to 280° C.

Embodiment 25 is the method of Embodiment 24, further including increasing the compound removal efficiency of the catalytic article including: adding ammonia (NH₃) in a concentration ranging from 0.0001% to 0.5% of the concentration of the flue gas stream; and increasing the temperature of the flue gas stream up to from 240° C. to 280° C. In some embodiments, the compound may be NOx.

Embodiment 26 is the method of Embodiment 24, further including increasing the compound removal efficiency of the catalytic article including: increasing the NO₂ concentration to a range from 2% to 99% of a total concentration of NOx in the first gas stream by introducing additional NO₂ into the flue gas stream.

Embodiment 27 is a method for preparing a catalyst including mixing a catalyst precursor having a metal and a ligand with a support material to form a mixture, the support material including TiO₂; calcining the mixture; and adding a secondary material to the support material such that the crystal structure of TiO₂ remains substantially the same.

Embodiment 28 is the method of Embodiment 27, wherein the metal is selected from one or more of transition metals, alkali or alkaline earth metals, or salts thereof.

Embodiment 29 is the method of Embodiments 27-28, wherein the metal is selected from the group consisting of vanadium, molybdenum, copper, iron, or mixtures thereof.

Embodiment 30 is the method of Embodiments 27-29, wherein the ligand is a carbonyl, oxalate, ammonium, cyclopentadienyl, diketonate or a ligand of formula I:

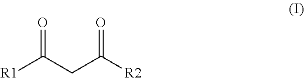

wherein R1 and R2 are independently alkyl, substituted alkyl, aryl, substituted aryl, acyl and substituted acyl.

Embodiment 31 is the method of Embodiments 27-30, wherein the catalyst precursor is selected from the group consisting of vanadyl acetylacetonate, vanadium (III) acetylacetonate, bis(acetylacetonato) dioxomolybdenum (VI), Iron(III) acetylacetonate, and copper (II) acetylacetonate.

Embodiment 32 is the method of Embodiments 27-31, wherein the catalyst has a content of the metal of from 4 wt. % to 50 wt. % based on the total weight of the catalyst.

Embodiment 33 is the method for preparing a catalyst including: mixing a catalyst precursor comprising a metal and a ligand with a support material to form a mixture, and calcining the mixture. In some embodiments, the support material includes TiO₂ having a crystal structure including an anatase phase and a secondary material.

Embodiment 34 is the method for preparing a catalyst including: mixing TiO₂ with a secondary material to form a support material including TiO₂ having a crystal structure including an anatase phase; mixing a catalyst precursor including a metal and a ligand with the support material to form a mixture; and calcining the mixture.

Embodiment 35 is the method of Embodiments 27-34, wherein the secondary material is selected from the group consisting of SiO₂, MoO₃, WO₃, and Al₂O₃.

The foregoing Examples are just that, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a bar graph showing comparative data of NOx removal efficiency of various catalysts at different temperatures, in accordance with embodiments;

FIG. 2 is a line graph showing comparative apparent reaction rate constants of various catalysts at different temperatures, in accordance with embodiments;

FIG. 3 is a line graph showing relative NOx removal efficiency for two different catalyst when exposed to SO₂ over a period of time, in accordance with embodiments;

FIG. 4 is a bar graph showing initial deactivation rate for two different catalyst when exposed to SO₂ over a period of time, in accordance with embodiments;

FIG. 5 is a graph showing X-ray diffraction patterns for various support materials and a catalyst containing TiO2, in accordance with embodiments;

FIG. 6 is a flowchart illustrating a method for reducing an amount of a compound from a gas stream, in accordance with an embodiment;

FIG. 7 is a flowchart illustrating a method for reducing an amount of a compound from a gas stream, in accordance with an embodiment.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

As used herein, the term “dioxin-like compound” means compounds including Polychlorinated dibenzo-p-dioxins (“PCDDs” or “dioxins”), polychlorinated dibenzofurans (“PCDFs or “furans”), polychlorinated biphenyls (“PCBs”), or polybrominated analogs of dioxins, furans, and PCBs.

The term “NOx” means nitrogen oxides, such as NO or NO₂.

The term “DeNOx catalyst” means catalysts used for removal of NOx, sometimes used in emission control.

The term “apparent reaction rate constant (kₘ)” may be calculated as follows:

$$Apparent reaction rate constant ( {k}_{m} ) = - \frac{v}{W} \times ln ( 1 - DeNOx efficiency ) ,$$

where kₘ is the first order apparent reaction rate referred to the catalyst mass (cm³/g s), V is the gas flow rate under reaction conditions (cm³/s) and Wis the catalyst mass (g). DeNOx efficiency is defined as

$$DeNOx efficiency = \frac{Total NOx Removed}{Total NOx at inlet} = \frac{NOx concentration at inlet - NOx concentration at outlet}{NOx concentration at intlet}$$

The apparent reaction rate constant is a metric of the amount of gas treated per unit time and mass of catalyst.

The term “selective catalytic reduction (“SCR”)” means a means of converting NOx into diatomic nitrogen and water with the aid of a catalyst. A reducing agent (e.g., anhydrous ammonia (NH₃), aqueous ammonia (NH₄OH), or a urea (CO(NH₂)2) solution) is added to a stream of flue or exhaust gas and is reacted onto a catalyst. For example, during SCR of NOx, NH₃ is introduced as a reducing agent to react with NOx on the DeNOx catalyst surface.

The term “relative DeNOx efficiency” means the ratio of DeNOx efficiency at a given time in the deactivation cycle over the initial DeNOx efficiency for a fresh catalyst.

The term “initial deactivation rate” means the relative DeNOx efficiency drop over time.

### DESCRIPTION OF VARIOUS EMBODIMENTS

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

The present disclosure generally relates to SO₂ tolerant catalysts and methods for preparing a SO₂ tolerant supported catalyst which may include mixing a dry catalyst precursor including a metal and a ligand with a dry support material to form a mixture, and calcining the mixture.

In some embodiments, the catalyst may include a catalytically active component; and a support material including TiO₂ having a crystal structure having an anatase phase.

In some embodiments, the catalyst includes at least one catalytically active component. In some embodiments, the at least one catalytically active component includes at least one of: Vanadium Monoxide (VO), Vanadium Trioxide (V₂O₃), Vanadium Dioxide (VO₂), Vanadium Pentoxide (V₂O₅), Tungsten Trioxide (WO₃), Molybdenum Trioxide (MoO₃), Manganese Oxide (MnO₂), Iron (III) oxide, Iron (II) oxide, or any combination thereof. In an embodiment, the at least one catalytically active component includes at least one of: Vanadium Monoxide (VO), Vanadium Trioxide (V₂O₃), Vanadium Dioxide (VO₂), Vanadium Pentoxide (V₂O₅), or any combination thereof. In an exemplary embodiment, the at least one catalytically active component includes only V₂O₅.

In some instances, the support material includes a secondary material. In some embodiments, the secondary material may be SiO₂, Fe₂O₃, CrO₃, Re₂O₇, Nb₂O₅, K₂O, MoO₃, WO₃, Al₂O₃, or zeolite. In an exemplary embodiment, the secondary material is SiO₂.

In some embodiments, the support material has a crystal structure that exhibits a ratio [(Ia/Ib)×100] of an intensity of a peak indicating an anatase crystal present in a range of 2 θ=24.7° to 2 θ=25.7° of powder X-ray diffraction of the TiO₂ [Ia] to the intensity of the peak indicating the anatase crystal present in the range of 2 θ=24.7° to 2 θ=25.7° of powder X-ray diffraction of a standard sample composed of anatase titanium oxide [Ib] of from 30% to 360%. For example, the TiO₂ may be M311 Hombikat TiO₂ from Venator.

In some embodiments, the secondary material has a weight percentage of from about 2 wt. % to about 35 wt. %, or from about 3 wt. % to 30 wt. %, or from about 4wt. % to 25 wt. %, or of from about 5 wt. % to about 20 wt. %, or of from about 10 wt. % to about 15 wt. %, based on a total weight of the catalyst.

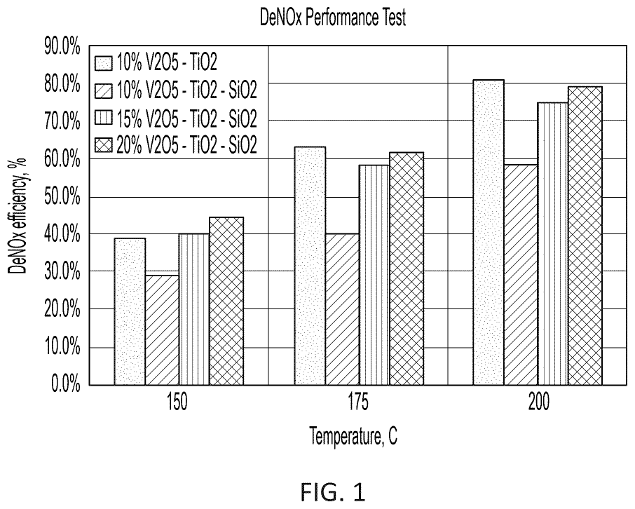

FIG. 1 is a bar graph showing comparative data of NOx removal efficiency (i.e. catalytic activity) of various catalysts at different temperatures, in accordance with embodiments. The data of FIG. 1 is calculated based on data collected according to Catalyst Evaluation Procedure 1, which will be discussed in further details below.

As shown, the catalyst may have a catalytic activity of from about 30% to about 90%, or of from about 40% to about 90%, or of from about 50% to about 90%, or of from about 60% to about 80%, or of from about 60% to about 80% at a temperature range of from 150° C. to 250° C. More specifically, the catalyst may have a catalytic activity of from about 60% to about 80%, or of from about 65% to about 80%, or of from about 70% to about 80% at a temperature range of from 170° C. to 220° C.

In some embodiments, the catalyst may exhibit a catalytic activity within a temperature range from 150° C. to 280° C., or from about 152° C. to 260° C., or from 155° C. to 240° C., or from 160° C. to 230° C., or from 165° C. to 225° C., or from 170° C. to 220° C., or from 175° C. to 220° C., or from 175° C. to 200° C.

For example, the catalyst may have a catalytic activity of from about 30% to about 90% at a temperature range of from 150° C. to 250° C., or the catalyst has a catalytic activity of from 60% to 80% at a temperature ranging from 170° C. to 220° C.

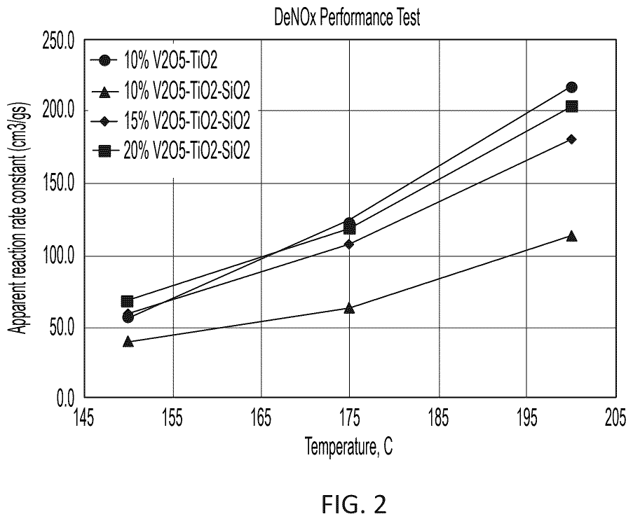

FIG. 2 is a line graph showing comparative apparent reaction rate constants of various catalysts at different temperatures, in accordance with embodiments. The data of FIG. 2 is calculated based on data collected according to Catalyst Evaluation Procedure 1, which will be discussed in further details below.

As shown, the catalyst may have an apparent reaction rate constant from about 40 to about 400 cm³/gs, or from about 50 to about 350 cm³/gs, or from about 60 to about 300 cm³/gs, or from about 70 to about 250 cm³/gs, or from about 80 to about 220 cm³/gs, or from about 90 to about 200 cm³/gs, or from about 100 to about 180 cm³/gs, or from about 110 to about 160 cm³/gs for a Selective Catalytic Reduction of NOx with NH₃.

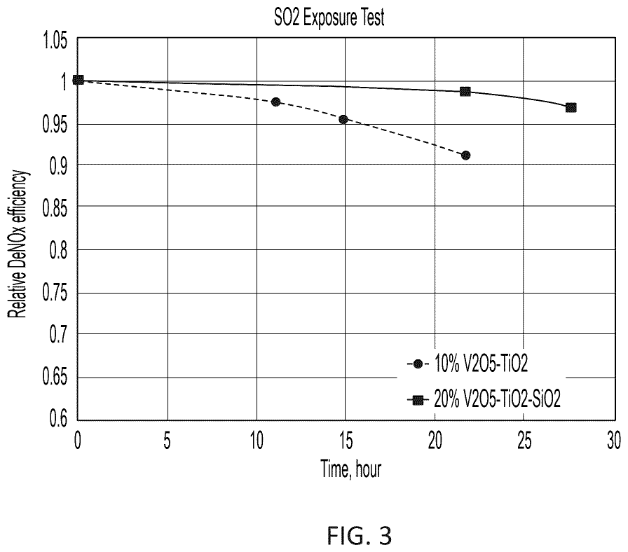

FIG. 3 is a line graph showing relative NOx removal efficiency for two different catalysts when exposed to SO₂ over a period of time, in accordance with embodiments. The data of FIG. 3 is calculated based on data collected according to Catalyst Evaluation Procedure 2, which will be discussed in further details below. As shown, the relative NOx removal efficiency of a catalyst having less catalytically active component and using TiO₂ as a support material reduces at a faster rate over time compared to a catalyst having more catalytically active component and using TiO₂ and a secondary material (SiO₂) as a support material.

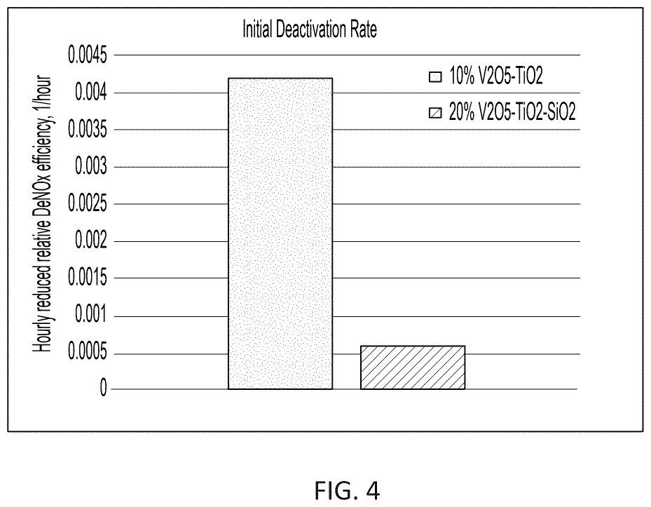

FIG. 4 is a bar graph showing initial deactivation rate for two different catalyst when exposed to SO₂ over a period of time, in accordance with embodiments. As shown, initial deactivation of a catalyst having less catalytically active component and using TiO₂ as a support material is larger compared to a catalyst having more catalytically active component and using TiO₂ and a secondary material (SiO₂) as a support material. In some embodiments, when tested in a Selective Catalytic Reduction of NOx with NH₃ in the presence of SO₂, a catalyst having more catalytically active component and using TiO₂-SiO₂ as a support material has a reduced initial deactivation rate compared to a catalyst having less catalytically active component and using TiO₂ as a support material.

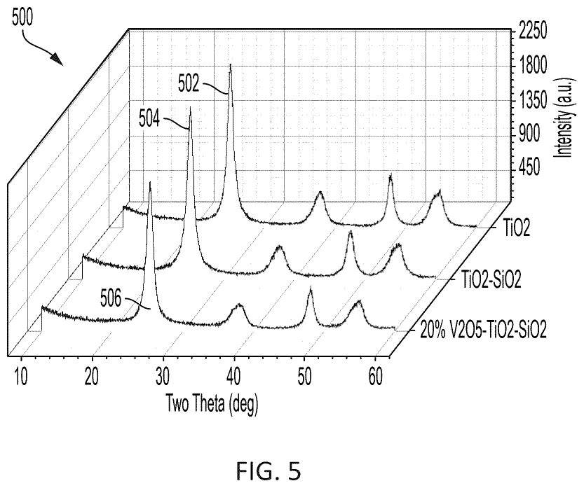

FIG. 5 is a graph showing X-ray diffraction patterns for various support materials and a catalyst containing TiO₂, in accordance with embodiments. Method of X-ray diffraction measurements will be discussed further in detail below in the Test Method section.

A peak indicating an anatase crystal typically presents in the range of 2 θ=24.7° to 2 θ=25.7°. As shown in FIG. 5, TiO₂ (Standard Sample, M311 Hombikat TiO₂ from Venator) has a high degree of crystallization of anatase-type titanium dioxide according to peak 502. In addition, both TiO₂—SiO₂ and 20% V₂O₅—TiO₂—SiO₂ (Catalyst Sample 4) samples have a high degree of crystallized anatase-type titanium dioxide according to peaks 504 and 506. The intensity (a.u.) of the peak 502 indicating anatase crystal titanium dioxide in the Standard Sample is 2177. The intensity (a.u.) of the peak 506 indicating anatase crystal titanium dioxide in the Catalyst Sample 4 is 1988. The ratio of the intensity of the peak 506 indicating an anatase crystal [Ia] in the Catalyst Sample to the intensity of peak 502 indicating an anatase crystal of the Standard Sample [Ib] is 91.3%.

In some embodiments, the support material may have a specific surface area from about 10 m²/g to about 3000 m²/g, from about 15 m²/g to about 2500 m²/g, from about 20 m²/g to about 2000 m²/g, from about 25 m²/g to about 1500 m²/g, from about 30 m²/g to about 1000 m²/g, from about 35 m²/g to about 800 m²/g, from about 40 m²/g to about 600 m²/g, from about 45 m²/g to about 500 m²/g, from about 50 m²/g to about 400 m²/g, from about 55 m²/g to about 350 m²/g, or may have a specific surface area encompassed within these ranges. In some embodiments, the support material may have a specific surface area from about 60 m²/g to about 340 m²/g, from about 65 m²/g to about 330 m²/g, from about 70 m²/g to about 320 m²/g, or from about 75 m²/g to about 310 m²/g. In an exemplary embodiment, the support material may have a specific surface area from about 50 m²/g to about 500 m²/g.

In some embodiments, the support material may include particles having a mean diameter of from about 0.5 μm to about 1000 μm, from about 0.6 μm to about 900 μm, from about 0.7 μm to about 800 μm, from about 0.8 μm to about 700 μm, from about 0.9 μm to about 600 μm, from about 1.0 μm to about 500 μm, from about 1.1 μm to about 400 μm, from about 1.2 μm to about 300 μm, from about 1.3 μm to about 200 μm, from about 1.4 μm to about 100 μm, or may include particles having a mean diameter encompassed within these ranges. In some embodiments, the support material 106 may include particles having a mean diameter of from about 1.5 μm to about 90 μm, from about 1.6 μm to about 80 μm, from about 1.7 μm to about 70 μm, from about 1.8 μm to about 60 μm, from about 1.9 μm to about 55 μm, or from about 1.95 μm to about 54 μm. In an exemplary embodiment, the support material may include particles having a mean diameter of from about 2.0 μm to about 52 μm. In another exemplary embodiment, the support material may include particles having a mean diameter of from 0.5 μm to 1000 μm

In some embodiments, the catalytically active component may have a loading percentage by weight of from about 4 wt. % to about 50 wt. %, from about 5 wt. % to about 45 wt. %, from about 6 wt. % to about 40 wt. %, from about 7 wt. % to about 35 wt. %, from about 8 wt. % to about 32.5 wt. %, from about 9 wt. % to about 30 wt. %, from about 10 wt. % to about 27.5 wt. %, from about 11 wt. % to about 25 wt. %, from about 12 wt. % to about 22.5 wt. %, from about 15 wt. % to about 20 wt. %, based on total weight of the catalyst. In yet another embodiment, the catalytically active component has a loading percentage by weight of 10% to 30%, based on the total weight of the catalyst.

As discussed above and shown in FIGS. 1-4, the DeNOx catalyst according to the present disclosure shows higher SO₂ tolerance through having a lower initial deactivation rate while maintaining catalyst activity compared to a catalyst having lower loading wt. % of catalytically active component and using only TiO₂ as a support material. In an exemplary embodiment, the DeNOx catalyst includes V₂O₅ as a catalytically active component, and TiO₂ and SiO₂ as a support material. As shown in FIG. 5, the anatase peak 506 of Catalyst Sample 4 is at substantially the same intensity (e.g., 91.3%) compared to the anatase peak 502 of the Standard Sample. Moreover, the peak 506 also maintains full width at half maximum (FWHM), suggesting the crystal structure of TiO₂ in Catalyst Sample 4 has not changed. Without wishing to be bound by theory, it is hypothesized that the reason why the crystal structure of TiO₂ in Catalyst Sample 4 has not changed is due to the location of SiO₂ being mainly in the pore or on an external surface of TiO₂, and not mixed with TiO₂ at the atomic level.

A catalytic article may include the catalyst described above and may further include at least one additional material. The additional material is not limited to any particular type of material and may be, for example, a membrane, a felt batt, a ceramic substrate (including but not limited to a ceramic candle), a honeycomb substrate, a monolith substrate, or any combination thereof. The catalytic composite article may, in some non-limiting examples, be a porous catalytic film. For example, the catalytic article may include a catalyst having an NOx removal efficiency of from about 20% to about 99%. In some embodiments, a method for catalyzing a reaction includes contacting a reactant stream with the catalyst described above. The NOx removal efficiency may be from about 10% to about 99% for the catalyst described above or the catalytic article including the catalyst.

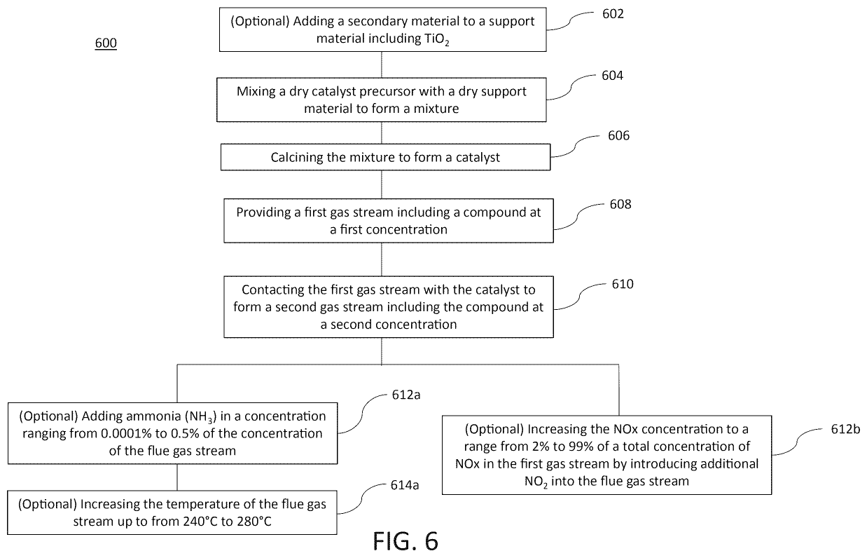

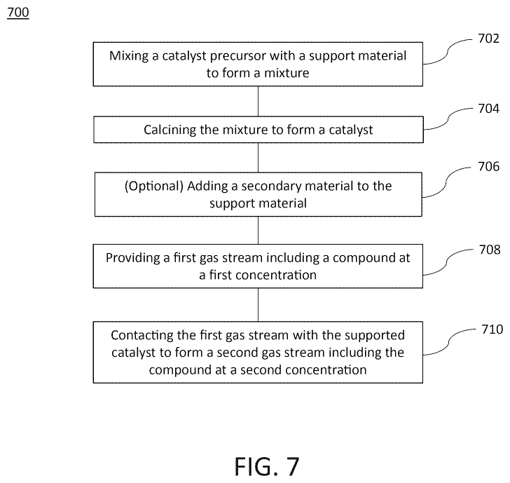

The methods shown in FIGS. 6-7 are examples of the various features of methods to prepare and or use the catalyst and, although the combination of those illustrated features is clearly within the scope of invention, that example and its illustration is not meant to suggest the inventive concepts provided herein are limited from fewer features, additional features, or alternative features to one or more of those features shown in FIGS. 6-7.

In addition, one or more steps of the below methods may be optional and/or may be modified by one or more steps of other embodiments described herein. Additionally, one or more steps of other embodiments described herein may be added to the method.

FIG. 6 is a flowchart illustrating a method 600 for reducing an amount of a compound from a gas stream, in accordance with an embodiment.

At step 602, the method 600 may optionally include adding a secondary material to the support material. In some embodiments, adding the secondary material to the support material maintains the crystal structure of TiO₂ in the support material to be substantially the same.

At step 604, the method 600 may include mixing a dry catalyst precursor with a dry support material to form a mixture. In some embodiments, the dry catalyst precursor may include a metal and a ligand. In some embodiments, the catalyst precursor may be free from any aqueous liquid or any organic liquid. In some embodiments, and the support material may be free from any aqueous liquid or any organic liquid.

In some embodiments, the dry support material may include TiO₂ having an anatase phase and a secondary material. In some embodiments, the dry support material is made by mixing TiO₂ with a secondary material to form a support material comprising of TiO₂ having a crystal structure of anatase phase; wherein the secondary material is selected from the group comprising at least one of SiO₂, Fe₂O₃, CrO₃, Re₂O₇, Nb₂O₅, K₂O, MoOs, WO₃, and Al₂O₃.

In some embodiments, the dry catalyst precursor may include a metal and a ligand. In some embodiments, the metal may be selected from one or more of transition metals, lanthanides, alkali or alkaline earth metals, or salts thereof. In some embodiments, the metal may be selected from Groups 3 to 14 of the Periodic Table of Elements, such as for example, V, Cr, Mn, Ce, Fe, Cu, Zn, Sn, Ta, Ni, Co, Nb, Sb, La, Eu, Gd.

In an exemplary embodiment, the metal is selected from the group consisting of vanadium, copper, iron, molybdenum, or mixtures thereof.

In some embodiments, the ligand may be a carbonyl, oxalate, ammonium, dimethylamino, bromide, chloride, cyclopentadienyl, diketonate or a ligand of Formula (I):

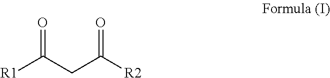

wherein R1 and R2 are independently alkyl, substituted alkyl, aryl, substituted aryl, acyl and substituted acyl.

In an exemplary embodiment, the catalyst precursor may include a metal and an acetylacetonate group or a ketone group. For example, the precursor may include Bis(2,2,6,6-tetramethyl-3,5-heptanedionato) zinc(II), Bis(acetylacetonato) dioxomolybdenum (VI), Chromium(III) acetylacetonate, Chromium(III) tris(2,2,6,6-tetramethyl-3,5-heptanedionate), Cobalt(II) hexafluoroacetylacetonate hydrate, Copper bis(2,2,6,6-tetramethyl-3,5-heptanedionate), Copper bis(6,6,7,7,8,8,8-heptafluoro-2,2-dimethyl-3,5-octanedionate), Copper(II) acetylacetonate, Copper(II) ethylacetoacetate, Copper(II) hexafluoroacetylacetonate hydrate, Copper(II) trifluoroacetylacetonate, Europium(III) acetylacetonate hydrate, Gadolinium(III) acetylacetonate hydrate, Iron(III) acetylacetonate, Lithium acetylacetonate, Manganese(II) acetylacetonate, Nickel(II) acetylacetonate, Nickel(II) bis(2,2,6,6-tetramethyl-3,5-heptanedionate), Nickel(II) hexafluoroacetylacetonate hydrate, Vanadyl acetylacetonate, Vanadium(III) acetylacetonate or Zinc acetylacetonate hydrate.

In an exemplary embodiment, the catalyst precursor is selected from the group consisting of vanadyl acetylacetonate, vanadium(III) acetylacetonate, bis(acetylacetonato) dioxomolybdenum(VI), Iron(III) acetylacetonate, and copper(II) acetylacetonate.

In some embodiments, step 604 may be performed using a vortex mixer, a shaking mixer, a double cone mixer, or a combination thereof. In some embodiments, step 604 may be performed using hand shaking in a scintillation vial. It is readily apparent that other mixing devices are suitable. In some embodiments, step 604 may be conducted under inert, dry or ambient conditions that is, for example, in the absence of O₂, with dry N₂ present.

In some embodiments, step 604 may be performed for a period of time of from about 30 seconds to about 10 hours, from about 35 seconds to about 9.5 hours, from about 40 seconds to about 9 hours, from about 45 seconds to about 8.5 hours, from about 50 seconds to about 8 hours, from about 55 seconds to about 7.5 hours, from about 1 minute to about 7 hours, from about 1.5 minutes to about 6.5 hours, from about 2 minutes to about 6 hours, from about 2.5 minutes to about 5.5 hours, from about 3 minutes to about 5 hours, or may be performed for a period of time encompassed within these ranges. In some embodiments, step 604 may be performed for a period of time of from about 30 seconds to about 4.5 hours, from about 40 seconds to about 4 hours, or from about 50 seconds to about 3.5 hours. In an exemplary embodiment, step 604 may be performed for a period of time of about 1 minute.

At step 606, the method 600 may include calcining the mixture to form a supported catalyst. The calcining step 606 may include heat treating the dry mixture formed in step 604. The calcining step 606 may be performed using standard calcining equipment such as, for example, a rotary calciner. In some embodiments, the mixing step 604 and the calcining step 606 may be conducted simultaneously (i.e., combined into one step). In some embodiments, the mixing step 604 and the calcining step 606 may be conducted consecutively.

In some embodiments, the calcining step 606 may be performed using a fast-heating method (e.g., heating the dry mixture in an aluminum pan placed on a pre-heated hot plate). In some embodiments, the calcining step 606 may be performed using a slowing-heating method (e.g., slowly heating the dry mixture in a crucible placed in a muffle oven starting at room temperature). In some embodiments, the mixture may be heated by being placed in a preheated oven.

In some embodiments, the dry mixture may be calcined at a temperature of from about 100° C. to about 500° C., from about 105° C. to about 480° C., from about 110° C. to about 460° C., from about 115° C. to about 440° C., from about 120° C. to about 430° C., from about 125° C. to about 420° C., from about 130° C. to about 410° C., from about 135° C. to about 400° C., from about 140° C. to about 390° C., from about 145° C. to about 380° C., or at a temperature encompassed within these ranges. In some embodiments, the dry mixture may be calcined at a temperature of from about 146° C. to about 375° C., from about 147° C. to about 370° C., or from about 148° C. to about 365° C. In an exemplary embodiment, the dry mixture may be calcined at a temperature of about 360° C.

In some embodiments, the dry mixture may be calcined at a rate of from about 1° C./min to about 50° C./min, from about 1.25° C./min to about 45° C./min, from about 1.5° C./min to about 40° C./min, from about 1.75° C./min to about 35° C./min, from about 2° C./min to about 30° C./min, from about 2.25° C./min to about 25° C./min, from about 2.5° C./min to about 20° C./min, from about 2.75° C./min to about 15° C./min, from about 3° C./min to about 10° C./min, or at a rate encompassed within these ranges. In some embodiments, the dry mixture may be calcined at a rate of from about 3.2° C./min to about 9° C./min, from about 3.4° C./min to about 8° C./min, from about 3.6° C./min to about 7° C./min, or from about 3.8° C./min to about 6° C./min. In an exemplary embodiment, the dry mixture may be calcined at a rate of from about 4° C./min to about 5° C./min.

In some embodiments, the dry mixture is calcined in an atmosphere containing from about 1 to about 25 vol. % oxygen, from about 2 to about 20vol. % oxygen, from about 3 to about 15 vol. % oxygen, from about 3.5 to about 10 vol. % oxygen, from about 4 to about 9 vol. % oxygen, from about 4.5 to about 8 vol. % oxygen, from about 5 to about 7 vol. % oxygen, from about 5.5 to about 6.5 vol. % oxygen, or containing a vol. % oxygen encompassed within these ranges. In an exemplary embodiment, the dry mixture may be calcined in an atmosphere containing about 21vol. % oxygen.

In an exemplary embodiment, the dry catalyst precursor may be a vanadyl acetylacetonate or vanadium(III) acetylacetonate, the support material may be TiO₂—SiO₂, and calcining may be conducted at a temperature of about 360° C.

A catalyst may be prepared through steps 604, 606, and optionally 602 in method 600. In some embodiments, the catalyst has a content of the metal (wt. %) based on the total weight of the catalyst. In some embodiments, the catalyst has a content of the metal of from about 0.1 wt. % to about 50 wt. %, from about 0.25 wt. % to about 45 wt. %, from about 0.5 wt. % to about 40 wt. %, from about 1 wt. % to about 35 wt. %, from about 1.5 wt. % to about 32.5 wt. %, from about 2.0 wt. % to about 30 wt. %, from about 2.25 wt. % to about 27.5 wt. %, from about 2.5 wt. % to about 25 wt. %, from about 2.75 wt. % to about 22.5 wt. %, from about 3.0 wt. % to about 20 wt. %, or has a content of the metal (wt. %) encompassed within these ranges. In some embodiments, the catalyst has a content of the metal of from about 3.2 wt. % to about 19 wt. %, from about 3.4 wt. % to about 18 wt. %, from about 3.6 wt. % to about 17 wt. %, or from about 3.8 wt. % to about 16 wt. %. In an embodiment, the catalyst has a content of the metal of from about 4 wt. % to about 50 wt. %. In an exemplary embodiment, the catalyst has a content of the metal of from about 20 wt. %.

In some embodiments, the catalyst has an NOx removal efficiency of from about 1% to about 99%, from about 5% to about 90%, from about 10% to about 80%, from about 15% to about 70%, from about 20% to about 60%, or has an NOx removal efficiency encompassed within these ranges.

At step 608, the method 600 may include providing a first gas stream including a compound at a concentration. At step 610, the method 600 may include contacting the gas stream with the catalyst formed at step 606 to form a second gas stream having the compound at a second concentration. In some embodiments, the method 600 may include contacting the gas stream with a catalytic article including the catalyst formed at step 606 to form a second gas stream comprising the compound at a second concentration. In an exemplary embodiment, the compound may include NOx, including for example Nitric Oxide (NO) and/or Nitrogen Dioxide (NO2). The compound may also include at least one of Nitrogen (N2), dioxin or a dioxin-like compound, a halogen, or a halogenated compound. In some instances, the first gas stream may further include at least one of Oxygen (O₂), Water (H₂O), Carbon Monoxide (CO), Carbon Dioxide (CO₂), Sulfur Dioxide (SO₂), Sulfur Trioxide (SO₃), a hydrocarbon, or one or more organic or inorganic materials and the like. In an exemplary embodiment, the gas stream is a flue gas stream having a temperature of between 140 to 250° C.

In some embodiments, the first gas stream having a first concentration of the compound is upstream, and the second gas stream having a second concentration of the compound is downstream. In some embodiments, the first concentration is greater than the second concentration.

The first gas stream may include SO₂ at a concentration of from about 1 to 200 ppm, or from about 10 to 180 ppm, or from about 20 to 160 ppm, or from about 30to 140 ppm, or from about 40 to 120 ppm, or from about 50 to 100 ppm.

In some embodiments, at step 612a, the compound mentioned above may include NOx, and the method 600 may optionally include adding ammonia (NH₃) in a concentration ranging from 0.0001% to 0.5% of the concentration of the flue gas stream.

In some embodiments, the increasing of the NOx removal efficiency of the catalytic article includes adding ammonia in a concentration ranging from 0.0001% to 0.5% of the concentration of the flue gas stream. In some embodiments, the increasing of the NOx removal efficiency of the catalytic article includes adding ammonia a concentration ranging from 0.001% to 0.5% of the concentration of the flue gas stream. In some embodiments, the increasing of the NOx removal efficiency the catalytic article includes adding ammonia in a concentration ranging from 0.01% to 0.5% of the concentration of the flue gas stream. In some embodiments, the increasing of the NOx removal efficiency of the catalytic article includes adding ammonia in a concentration ranging from 0.1% to 0.5% of the concentration of the flue gas stream.

In some embodiments, the increasing of the NOx removal efficiency of the catalytic article includes adding ammonia in a concentration ranging from 0.0001% to 0.1% of the concentration of the flue gas stream. In some embodiments, the increasing of the NOx removal efficiency of the catalytic article includes adding ammonia in a concentration ranging from 0.0001% to 0.05% of the concentration of the flue gas stream. In some embodiments, the increasing of the NOx removal efficiency of the catalytic article includes adding ammonia in a concentration ranging from 0.0001% to 0.005% of the concentration of the flue gas stream.

In some embodiments, the increasing of the NOx removal efficiency of the catalytic article includes adding ammonia in a concentration ranging from 0.005% to 0.1% of the concentration of the flue gas stream. In some embodiments, the increasing of the NOx removal efficiency of the catalytic article includes adding ammonia in a concentration ranging from 0.005% to 0.05% of the concentration of the flue gas stream.

At a subsequent step 614a, the method 600 may optionally include increasing the temperature of the flue gas stream up to from 240° C. to 280° C.

Alternatively, at step 612b, the method 600 may optionally include increasing the NO₂ concentration to a range from 2% to 99% of a total concentration of NOx in the first gas stream by introducing additional NO₂ into the flue gas stream.

Performing optional steps 612a, 614a, and 612b may increase the compound removal efficiency of the catalytic article, thus regenerating the catalyst.

FIG. 7 is a flowchart illustrating a method for reducing an amount of a compound from a gas stream, in accordance with an embodiment.

At step 702, the method 700 may include mixing a dry catalyst precursor with a dry support material to form a mixture. In some embodiments, the dry catalyst precursor may include a metal and a ligand. In some embodiments, the catalyst precursor may be free from any aqueous liquid or any organic liquid. In some embodiments, and the support material may be free from any aqueous liquid or any organic liquid.

In some embodiments, the dry catalyst precursor may include a metal and a ligand. In some embodiments, the metal may be selected from Groups 3 to 14 of the Periodic Table of Elements, such as for example, V, Cr, Mn, Ce, Fe, Cu, Zn, Sn, Ta, Ni, Co, Nb, Sb, La, Eu, Gd. In an exemplary embodiment, the metal is selected from the group consisting of vanadium, copper, iron, molybdenum, or mixtures thereof.

In some embodiments, the dry support material may include TiO₂ having an anatase phase. The dry support material may additionally include a secondary material. In some embodiments, the dry support material is made by mixing TiO₂ with a secondary material to form a support material comprising of TiO₂ having a crystal structure of anatase phase; wherein the secondary material is selected from the group comprising at least one of SiO₂, Fe₂O₃, CrO₃, Re₂O₇, Nb₂O₅, K₂O, MoO₃, WO₃, and Al₂O₃. In some embodiments, the dry support material may be a commercially available mixture of TiO₂ and a secondary material.

At step 704, the method 700 may include calcining the mixture to form a supported catalyst. The calcining step 704 may include heat treating the dry mixture formed in step 702. The calcining step 704 may be performed using standard calcining equipment such as, for example, a rotary calciner. In some embodiments, the mixing step 702 and the calcining step 704 may be conducted simultaneously (i.e., combined into one step). In some embodiments, the mixing step 702 and the calcining step 704 may be conducted consecutively.

In some embodiments, the calcining step 704 may be performed using a fast-heating method (e.g., heating the dry mixture in an aluminum pan placed on a pre-heated hot plate). In some embodiments, the calcining step 704 may be performed using a slowing-heating method (e.g., slowly heating the dry mixture in a crucible placed in a muffle oven starting at room temperature). In some embodiments, the mixture may be heated by being placed in a preheated oven.

In some embodiments, the method 700 may optionally include step 706. At optional step 706, the method 700 may include adding a secondary material to the support material, the support material including TiO₂ having an anatase phase. In some embodiments, the optional step 706 includes adding a secondary material to the support material such that the crystal structure of TiO₂ remains substantially the same. In some instances, the secondary material is selected from the group comprising at least one of SiO₂, Fe₂O₃, CrO₃, Re₂O₇, Nb2O₅, K₂O, MoO₃, WO₃, Al₂O₃, and zeolite.

At step 708, the method 700 may include providing a first gas stream including a compound at a concentration. At step 710, the method 700 may include contacting the gas stream with the catalyst to form a second gas stream having the compound at a second concentration. In some embodiments, the method 700 may include contacting the gas stream with a catalytic article including the catalyst to form a second gas stream comprising the compound at a second concentration. In an exemplary embodiment, the compound may include NOx, including for example Nitric Oxide (NO) and/or Nitrogen Dioxide (NO₂). The compound may also include at least one of Nitrogen (N₂), dioxin or a dioxin-like compound, a halogen, or a halogenated compound. In some instances, the first gas stream may further include at least one of Oxygen (O₂), Water (H₂O), Carbon Monoxide (CO), Carbon Dioxide (CO₂), Sulfur Dioxide (SO₂), Sulfur Trioxide (SO₃), a hydrocarbon, or one or more organic or inorganic materials and the like. In an exemplary embodiment, the gas stream is a flue gas stream having a temperature of between 140 to 250° C.

In some embodiments, the first gas stream having a first concentration of the compound is upstream, and the second gas stream having a second concentration of the compound is downstream. In some embodiments, the first concentration is greater than the second concentration.

### TEST METHODS

It should be understood that although certain methods and equipment are described below, other methods or equipment determined suitable by one of ordinary skill in the art may be alternatively utilized.

### Catalyst Evaluation Procedure pb 1

### Catalyst Powder Performance Test for NOx Removal

The following procedure was used to test performance of the catalyst for NOx removal. The NOx removal reaction of as prepared catalyst powder was carried out in a fixed-bed quartz flow reactor at different temperatures. 0.1 gram catalyst powder was used during the test. The feed gas mixture contained 100 ppm NO, 20 ppm NO₂, 105 ppm NH₃, 6 vol. % O₂ and N₂ as balance. The NOx removal reaction was measured with a total flowrate of 0.45 L/min. To determine NOx removal efficiency, the upstream (i.e., the concentration of NOx entering into the chamber before exposure to the catalyst powder) and downstream concentration of NOx were monitored with a MKS MULTI-GASTM 2030D FTIR analyzer (MKS Instruments, Andover, MA).

NOx removal efficiency (i.e., “DeNOx efficiency (%)”) was calculated based on the following equation:

$$DeNOx efficiency ( \% ) = \frac{NOx in - NOx out}{NOx in} \times 100 \%$$

where NOx=total concentration of NO and NO₂ in the stream
NOx in=upstream concentration of NOx
NOx out=downstream concentration of NOx

Apparent reaction rate constant (km) was calculated based on the following equation:

$$Apparent reaction rate constant ( {k}_{m} ) = - \frac{v}{W} \times ln ( 1 - DeNOx efficiency )$$

where kₘ=first order apparent reaction rate referred to the catalyst mass (cm³/g s)
v=gas flow rate under reaction conditions (cm³/s)
W=catalyst mass (g)

### Catalyst Evaluation Procedure 2

### Catalyst Powder Performance Test with SO₂

The following procedure was used to test performance of the catalyst for NOx removal when exposed to SO₂. The NOx removal reaction under SO₂ exposure condition of as prepared catalyst powders was carried out in a fixed-bed quartz flow reactor at 220° C. 0.1 g catalyst powder mixed with 0.5 g silicon carbide (Sigma Aldrich) was used during the test. The feed gas mixture contained 200 ppm NO, 9 ppm SO₂, 200 ppm NH₃, 6 vol % O_{2pv , 5} vol % moisture and N₂ as balance. The NOx removal reaction was measured with a total flowrate of 0.8 L/min. To determine NOx removal efficiency, the upstream (i.e., the concentration of NOx entering into the chamber before exposure to the catalyst powder) and downstream concentration of NOx were monitored with a MKS MULTI-GASTM 2030D FTIR analyzer (MKS Instruments, Andover, MA). NOx removal efficiency was calculated according to the following equation:

$$DeNOx efficiency ( \% ) = \frac{NOx in - NOx out}{NOx in} \times 100 \%$$

where NOx=total concentration of NO and NO₂ in the stream
NOx in=upstream concentration of NOx
NOx out=downstream concentration of NOx

Relative DeNOx efficiency was calculated based on the following equation:

$$Relative DeNox efficiency = \frac{DeNOx efficiency at time {}^{‶} {t}^{″}}{Initial DeNOx efficiency at time {}^{‶} {0}^{″}}$$

Initial Deactivation rate of the first 21 hours was calculated based on the following equation:

$$Initial Deactivation rate = 1 - \frac{Relative DeNox efficiency ( at time {}^{‶} {21}^{″} hour )}{21}$$

### X-Ray Diffraction Measurement

X-ray diffraction measurement was conducted on Rigaku SmartLab high-resolution X-ray diffractometer with Cu Kα (40 kV/45 mA) source. Incident optics used were parallel beam cross-beam optics (5° Soller Slit, 1.0 mm divergent slit, 10 mm length-limiting slit). Receiving optic was nickel filter for Cu Kβ (5° Soller Slit, 2.0- and 2.1-mm receiving slits, HyPix 3000 detector operating in zero-D continuous mode). Scanning setting was 10-60° 2 θ range, 0.02° increment, 2.0° /min. Powder was placed into 20×20×0.5 mm well of a glass plate. Sufficient powder was used to fill the whole volume of well, and pressed flat with glass spacer. Excess amount of powder was scraped off by razor.

### EXAMPLES

### Example 1

### Preparation of Catalyst Sample 1

10 wt. % V₂O₅p13 TiO₂ catalyst powder was prepared by adding 0.116 gram of vanadyl acetylacetonate (Sigma-Aldrich) into 0.36 gram of TiO₂ (Hombikat M311, with a specific surface area of about 304 m²/g) into a scintillation vial. The two dry powders were mixed by shaking on a Vortex Mixer (Cole-Parmer) for 1 minute. Afterwards, the powder mixture was transferred to an aluminum weight dish and thermal treated at 300° C. for 3 hours with a temperature ramp rate of 5° C./min.

### Example 2

### Preparation of Catalyst Sample 2

10 wt. % V₂O₅—TiO₂—SiO₂ catalyst powder was prepared by adding 0.116 gram of vanadyl acetylacetonate (Sigma-Aldrich) into 0.36 gram of TiO₂—SiO₂ (Hombikat M411-10% SiO₂, with a specific surface area of about 291 m²/g) into a scintillation vial. The two dry powders were mixed by shaking on a Vortex Mixer (Cole-Parmer) for 1 minute. Afterwards, the powder mixture was transferred to an aluminum weight dish and thermal treated at 360° C. for 3 hours with a temperature ramp rate of 5° C./min.

### Example 3

### Preparation of Catalyst Sample 3

15 wt. % V₂O₅-TiO₂-SiO₂ catalyst powder was prepared by adding 0.167 gram of vanadyl acetylacetonate (Sigma-Aldrich) into 0.344 gram of TiO₂-SiO₂ (Hombikat M411-10% SiO₂, with a specific surface area of about 291 m²/g) into a scintillation vial. The two dry powders were mixed by shaking on a Vortex Mixer (Cole-Parmer) for 1 minute. Afterwards, the powder mixture was transferred to an aluminum weight dish and thermal treated at 360° C. for 3 hours with a temperature ramp rate of 5° C./min.

### Example 4

### Preparation of Catalyst Sample 4

20wt. % V₂O₅—TiO₂—SiO₂ catalyst powder was prepared by adding 0.233 gram of vanadyl acetylacetonate (Sigma-Aldrich) into 0.32 gram of TiO₂-SiO₂ (Hombikat M411-10% SiO₂, with a specific surface area of about 291 m²/g) into a scintillation vial. The two dry powders were mixed by shaking on a Vortex Mixer (Cole-Parmer) for 1 minute. Afterwards, the powder mixture was transferred to an aluminum weight dish and thermal treated at 360° C. for 3 hours with a temperature ramp rate of 5° C./min.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

1-35. (canceled)

36. A catalyst comprising:
a catalytically active component; and
a support material comprising TiO₂ having a crystal structure comprising an anatase phase;
wherein the support material comprises a secondary material.

37. The catalyst of claim 36, wherein the secondary material is selected from the group comprising at least one of SiO₂, MoO₃, WO₃, and Al₂O₃, and wherein the secondary material has a weight percentage of from 2% to 35% based on a total weight of the catalyst.

38. The catalyst of claim 36, wherein a ratio [(Ia/Ib)×100] of an intensity of a peak indicating an anatase crystal present in a range of 2 θ=24.7° to 2 θ=25.7° of powder X-ray diffraction of the TiO₂ [Ia] to the intensity of the peak indicating the anatase crystal present in the range of 2 θ=24.7° to 2 θ=25.7° of powder X-ray diffraction of a standard sample composed of anatase titanium oxide [Ib] is from 30% to 360%.

39. The catalyst of claim 36, wherein the catalyst has an NOx removal efficiency of from 30% to 90% at a temperature range of from 150° C. to 280° C. and an apparent reaction rate constant from 40 to 400 cm³/gs at a temperature range of from 150° C. to 280° C. for a Selective Catalytic Reduction of NOx with NH₃.

40. The catalyst of claim 36, wherein the catalyst has an NOx removal efficiency of from 60% to 80% from a temperature ranging from 170° C. to 220° C., and wherein the catalyst has a reduced initial deactivation rate compared to a catalyst comprising a support material consisting of TiO₂ when tested in a Selective Catalytic Reduction of NOx with NH₃ in the presence of SO₂, and wherein the support material has a specific surface area of from 50 to 500 m²/g.

41. The catalyst of claim 36, wherein the catalytically active component comprises at least one of: Vanadium Monoxide (VO), Vanadium Trioxide (V₂O₃), Vanadium Dioxide (VO₂), Vanadium Pentoxide (V₂O₅), Molybdenum Trioxide (MoO₃), Manganese Oxide (MnO₂), Iron(III) oxide (Fe₂O₃), Iron(II) oxide (FeO), Copper Oxide (CuO) or any combination thereof, and wherein the catalytically active component has a loading percentage by weight of 4% to 50% based on total weight of the catalyst.

42. The catalyst of claim 36, wherein the support material comprises particles having a mean diameter of from 0.5 μm to 1000 μm, and wherein the catalytically active component is V₂O₅, the support material is TiO₂, and the secondary material is SiO₂.

43. A catalytic article comprising the catalyst of claim 36, wherein the catalytic article has an NOx removal efficiency of from 10% to 99% at a temperature range of from 150° C. to 280° C.

44. A method for catalyzing a reaction comprising contacting a reactant stream with the catalyst of claim 36.

45. A method to reduce an amount of a compound from a gas stream comprising:
providing a first gas stream comprising the compound at a first concentration; and
contacting the gas stream with the catalytic article of claim 16 forming a second gas stream comprising the compound at a second concentration;
wherein the first concentration is greater than the second concentration.

46. The method of claim 45, wherein the first gas stream comprises SO₂ at a concentration of from 1 to 200 ppm, and wherein the compound comprises NOx.

47. The method of claim 45, wherein the compound comprises at least one of Nitrogen (N₂), dioxin or a dioxin-like compound, a halogen, or a halogenated compound, and wherein the first gas stream further comprises at least one of Oxygen (O₂), Water (H₂O), Carbon Monoxide (CO), Carbon Dioxide (CO₂), Sulfur Dioxide (SO₂), Sulfur Trioxide (SO₃), a hydrocarbon, or one or more organic or inorganic materials and the like, and wherein the gas stream is a flue gas stream having a temperature of between 140 to 280° C.

48. The method of claim 47, further comprising:
increasing the compound removal efficiency of the catalytic article comprising:
adding ammonia (NH₃) in a concentration ranging from 0.0001% to 0.5% of the concentration of the flue gas stream; and
increasing the temperature of the flue gas stream up to from 240° C. to 280° C.;
wherein the compound is NOx.

49. The method of claim 47, the method further comprising:
increasing the compound removal efficiency of the catalytic article comprising:
increasing the NO₂ concentration to a range from 2% to 99% of a total concentration of NOx in the first gas stream by introducing additional NO₂ into the flue gas stream.

50. A method for preparing a catalyst comprising:
mixing a catalyst precursor comprising a metal and a ligand with a support material to form a mixture, the support material comprising TiO2;
calcining the mixture; and
adding a secondary material to the support material such that the crystal structure of TiO₂ remains substantially the same.

51. The method of claim 50, wherein the metal is selected from one or more of transition metals, alkali or alkaline earth metals, or salts thereof.

52. The method of claim 50, wherein the metal is selected from the group consisting of vanadium, molybdenum, copper, iron, or mixtures thereof, and wherein the ligand is a carbonyl, oxalate, ammonium, cyclopentadienyl, diketonate or a ligand of formula I: 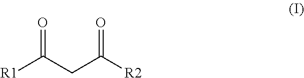
wherein R1 and R2 are independently alkyl, substituted alkyl, aryl, substituted aryl, acyl and substituted acyl.

53. The method of claim 50, wherein the catalyst precursor is selected from the group consisting of vanadyl acetylacetonate, vanadium (III) acetylacetonate, bis(acetylacetonato) dioxomolybdenum (VI), Iron(III) acetylacetonate, and copper (II) acetylacetonate, and wherein the catalyst has a content of the metal of from 4 wt. % to 50 wt. % based on the total weight of the catalyst.

54. A method for preparing a catalyst comprising:
mixing a catalyst precursor comprising a metal and a ligand with a support material to form a mixture, and calcining the mixture;
wherein the support material comprises TiO₂ having a crystal structure comprising an anatase phase and a secondary material.

55. The method of claim 54, wherein the secondary material is selected from the group consisting of SiO₂, MoO₃, WO₃, and Al₂O₃.
